(19) United States
(12) Patent Application Publication
(10) Pub. No.: US 2007/0039355 A1
(43) Pub. Date: Feb. 22, 2007

(54) Method for forming fine water molecules and apparatus for forming fine water molecules by using the same

(76) Inventors: Chung-Ting Chen, Taipei Hsien (TW); Hung-tu Chen, Taipei (TW)

Correspondence Address: Chung-Ting Chen, 235 Chung - Ho, Box 8-24, Taipei, TW

(21) Appl. No.: 11/204,259

(22) Filed: Aug. 16, 2005

(51) Int. Cl. C03B 5/00

(52) U.S. Cl. 65/134.1

(57) ABSTRACT

A method for fining water molecules mainly comprises the steps of driving the water to flow through a reverse osmosis device for filtering impurities; feeding the water to a heating device; feeding boiling water into a plurality of first mineral stone collision devices so as to form fine water molecules; cooling the fine water molecules; driving the cooling fine water molecules through a plurality of second mineral stone collision devices to fix the shape of the fine water molecules; driving the shape fine water molecules to flow through maifan stones; feeding the fine water molecules into a supersonic oscillating device and sterilizing germs in the water molecules by for example ultraviolet rays. An apparatus for forming fine water molecules is further comprised. Furthermore, a method for fining water molecules in beverage is disclosed, which has steps like the above mentioned steps for forming fine water molecules in water

### FIELD OF THE INVENTION

The present invention relates to method for forming fine water molecules, and in particular to a method for forming fine water molecules, wherein the water processed by the method of the present invention has fine water molecules and the effect can be retained through a long time period. Furthermore, an apparatus for forming fine water molecules by the method of the present invention is provided.

### BACKGROUND OF THE INVENTION

It is known that water is form by H₂O, but H₂O molecule cannot exist singly. A larger number of water molecules are combined to a great poly-structure, which is formed as grape series, rings or chains. That is so called water molecule groups. In general, each group of running water is formed by 10 to 16 water molecules. Currently, the water molecules in one group can be reduced by technology so as to form fine water molecules.

If the size of the water molecule group is finer and finer, the water molecules have preferred permeation ability and higher density. Thereby fine water molecules have many preferred properties, for example to clean skin completely, cleaning chemical agents, etc. Furthermore, higher percentage of oxygen is contained in the water with fine water molecules. Since oxygen is important to skin and hair and is important in anti-germs and sterilization. Thereby fine water molecules will be widely used in near future. It is beneficial in retaining the fresh of foods, or purifying foods, such as alcohols, coffees, teas, soy-bean sauce, vinegar, etc. Other than removing odor, the fine water molecules have the effect of treating atopic dermatitis, tinea in hands or legs.

However the current used product for manufacturing fine water molecules, such as water electrolyze machine, far infrared water fining machine, or biochemical ceramic fine water machine will make the fine water molecules return to the original larger sizes if the fine water molecules are retained through a long time period or the change of temperature.

### SUMMARY OF THE INVENTION

Accordingly, the primary object of the present invention is to provide a method for forming fine water molecules, wherein the water processed by the method of the present invention has fine water molecules and the effect can be retained through a long time period. Furthermore, an apparatus for forming fine water molecules by the method of the present invention is provided.

To achieve above objects, the present invention provides A method for fining water molecules comprising the steps of: a) feeding water in an inlet; b) driving the water to flow through a reverse osmosis device for filtering impurities; c) storing the water in a storage tank; d) feeding the water to a heating device for boiling the water into vapor; e) feeding the vapor into a plurality of first mineral stone collision devices so as to form fine water molecules; f) cooling the fine water molecules in a condenser; g) driving the cooling fine water molecules through a plurality of second mineral stone collision devices to fix the shape of the fine water molecules by this collision process; h) driving the shape fine water molecules to flow through maifan stones; i) forming fine water molecules as the water passing through the maifan stones, wherein the water molecules have long time period effect and have fine sizes; j) feeding the fine water molecules into a supersonic oscillating device for oscillating the water molecules by supersonic so as to stabilize the water molecules; and k) sterilizing germs in the water molecules by for example ultraviolet rays.

Furthermore, the present invention provides an apparatus for forming fine water molecules which comprises an reverse osmosis device having a water inlet; a storage tank for storing water processed by the RO reverse osmosis device; a heating device for boiling water in the storage tank into vapor; a plurality of mineral collision devices for colliding the water molecules into fine water molecules; a plurality of maifan stones for releasing minerals into waters; a supersonic oscillating device for stabilizing water molecules; and a storage tank for storing the fine water molecules.

The various objects and advantages of the present invention will be more readily understood from the following detailed description when read in conjunction with the appended drawing.

### BRIEF DESCRIPTION OF THE DRAWINGS

FIG. 1 is a flow diagram showing the method of the present invention.

FIG. 2 is a structural schematic view about the equipment of the present invention.

FIG. 3 is a schematic view about the structure of the first body of the present invention.

FIG. 4 is a schematic view about the structure of the second body of the present invention.

FIG. 5 is a schematic view about the structure of the third body of the present invention.

FIG. 6 is a schematic view about the structure of the fourth body of the present invention. FIG. 7 is a schematic view about the structure of the fifth body of the present invention.

FIG. 8 is a schematic view about the structure of the sixth body of the present invention.

FIG. 9 is a flow diagram of another embodiment of the present invention.

FIG. 10 shows the experimental result in one application of the present invention under the test of nuclear magnetic resonance.

FIG. 11 shows the experimental result under the test of nuclear magnetic resonance, where general running water is used as a sample.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

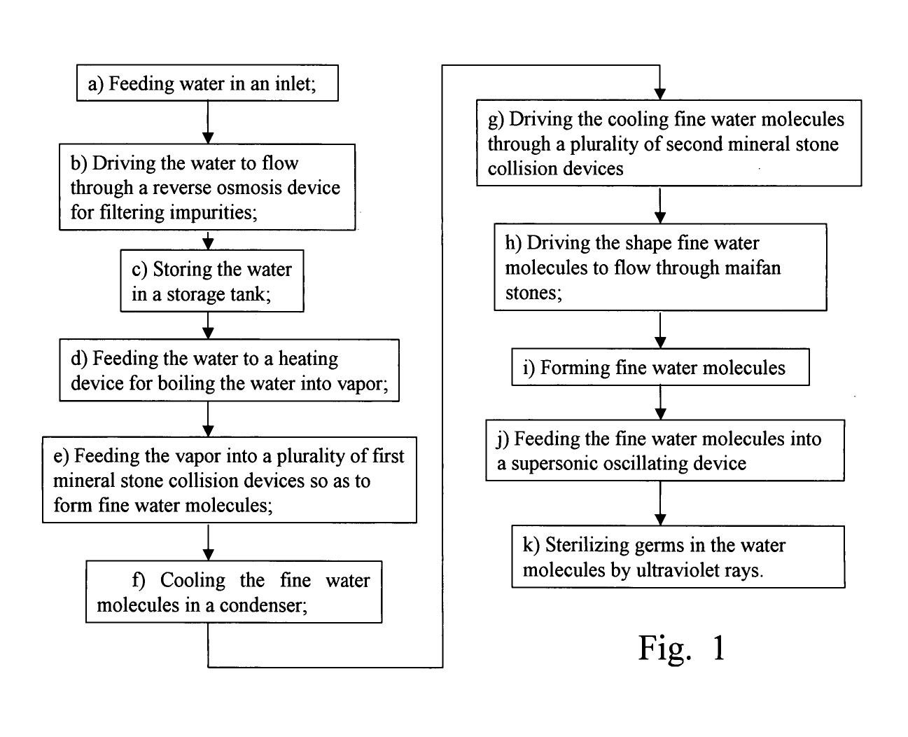

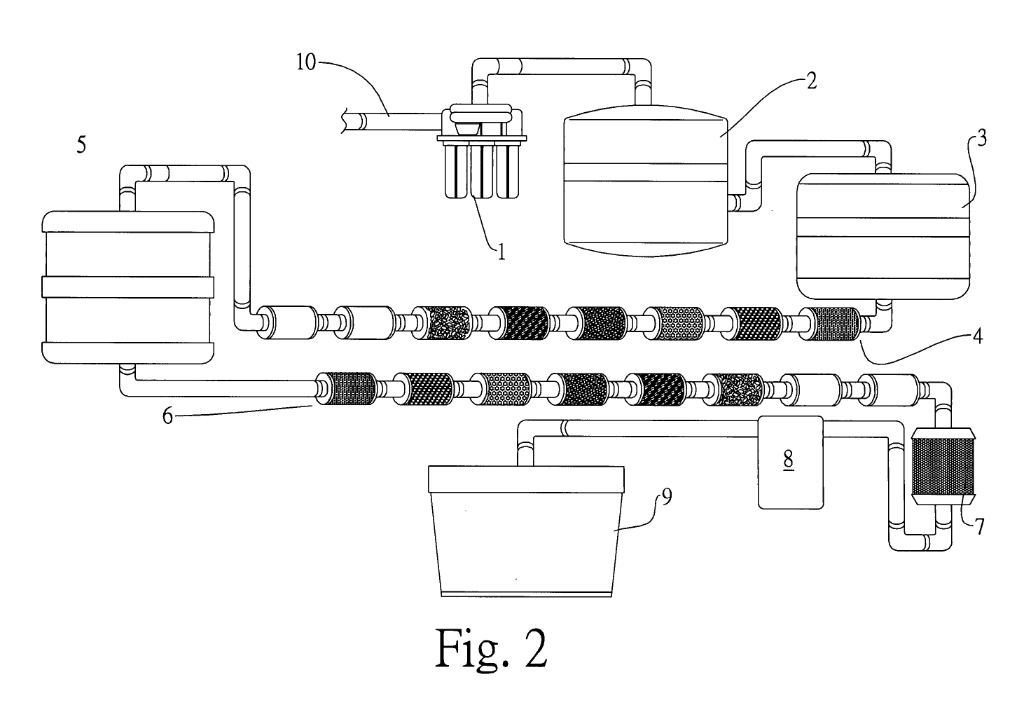

Referring to FIGS. 1 and 2, the method of the present invention will be described in the following. The method including the steps of:

a) feeding water in an inlet 10;

b) driving the water to flow through a reverse osmosis device 1 for filtering impurities;

c) storing the water in a storage tank 2;

d) feeding the water to a heating device 3 for boiling the water into vapor (pure water); wherein the heating device 3 may be a boiler;

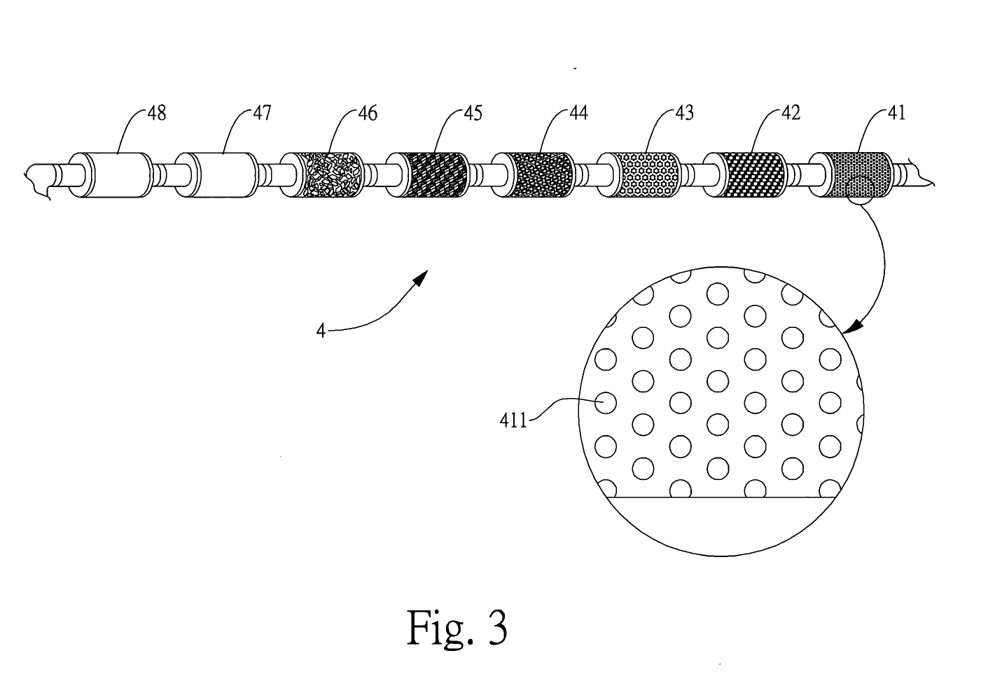

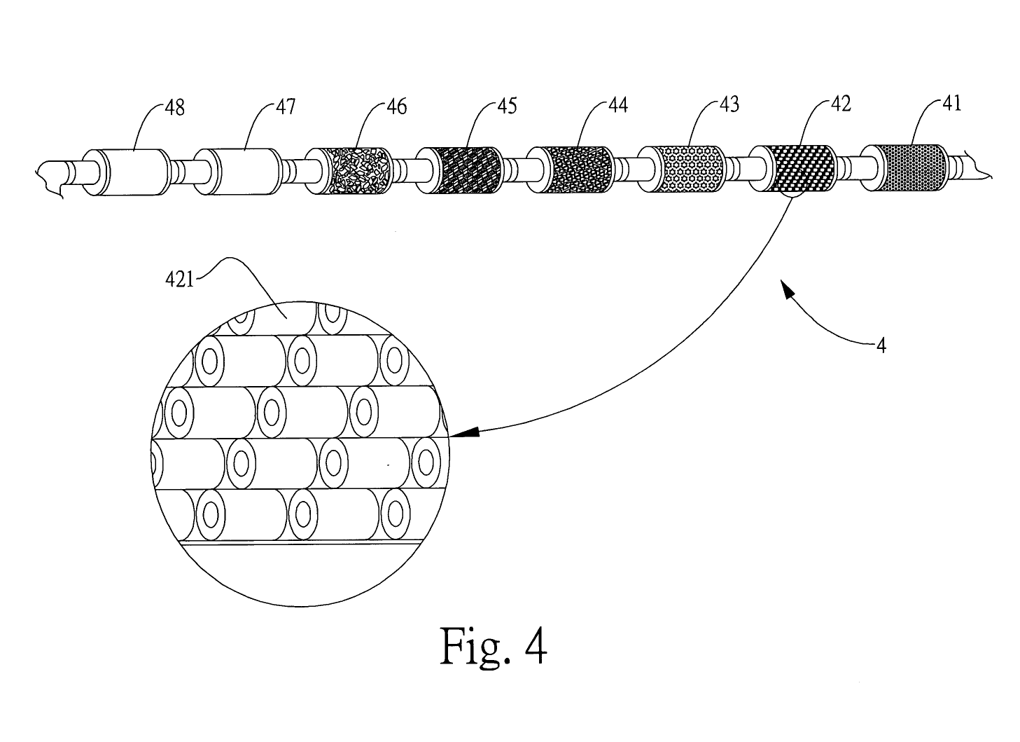

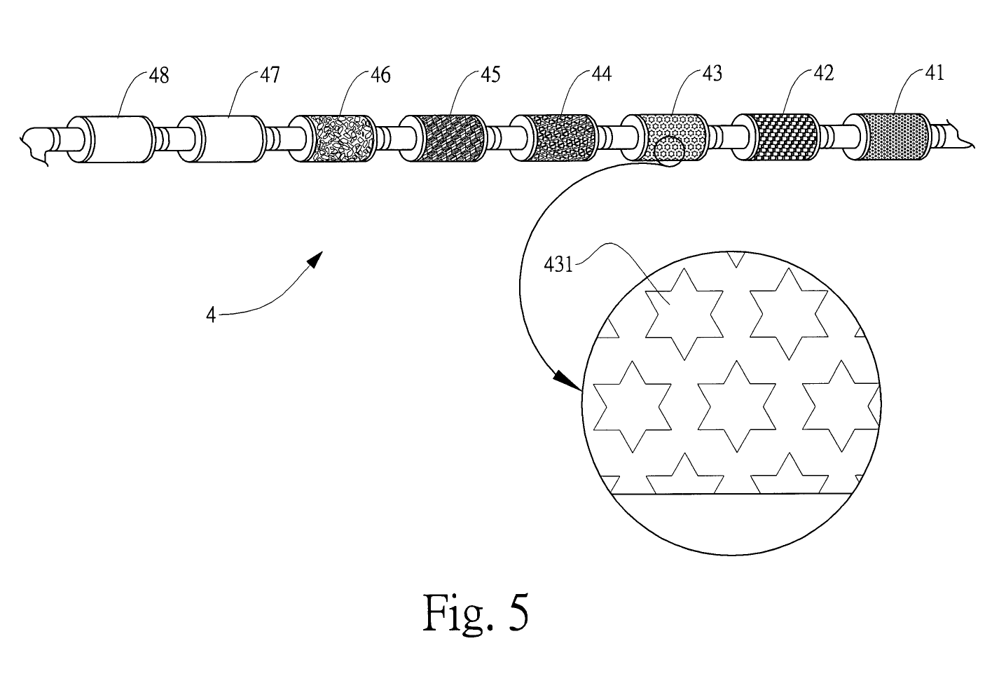

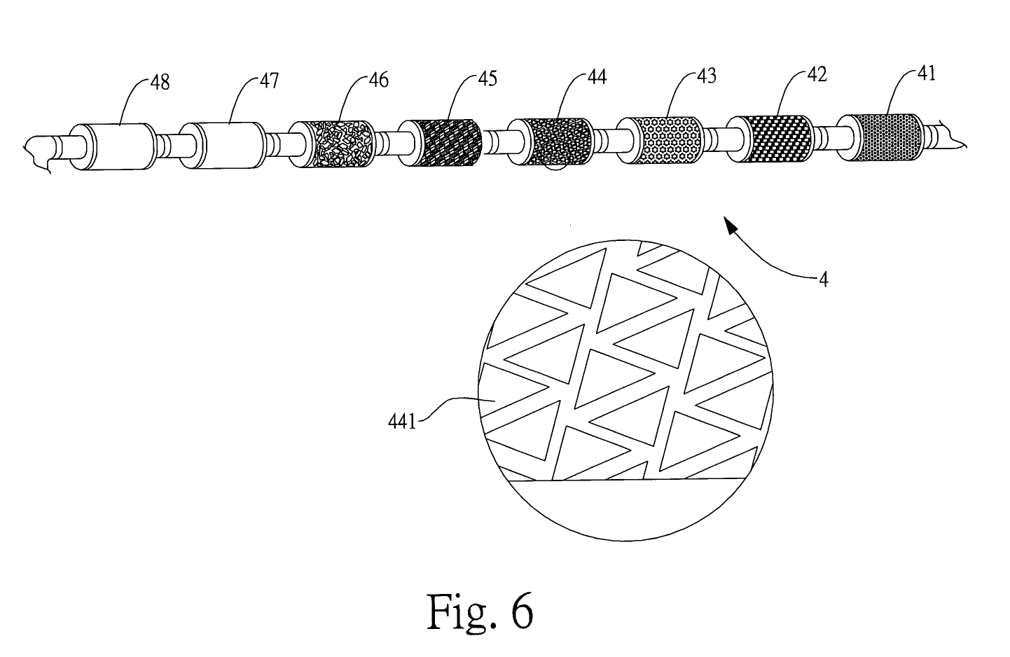

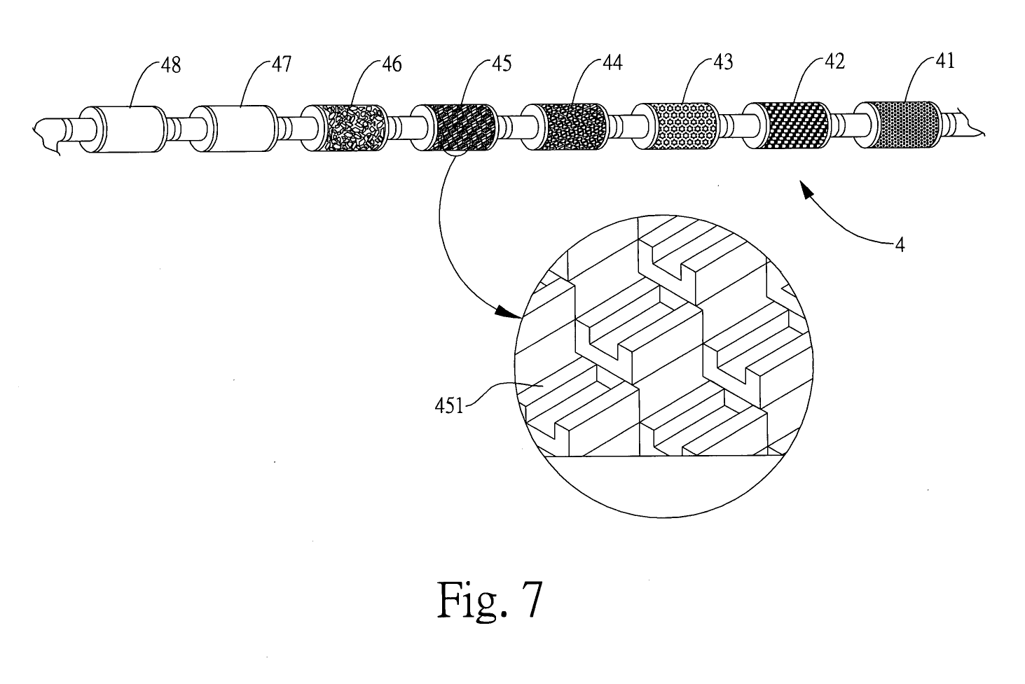

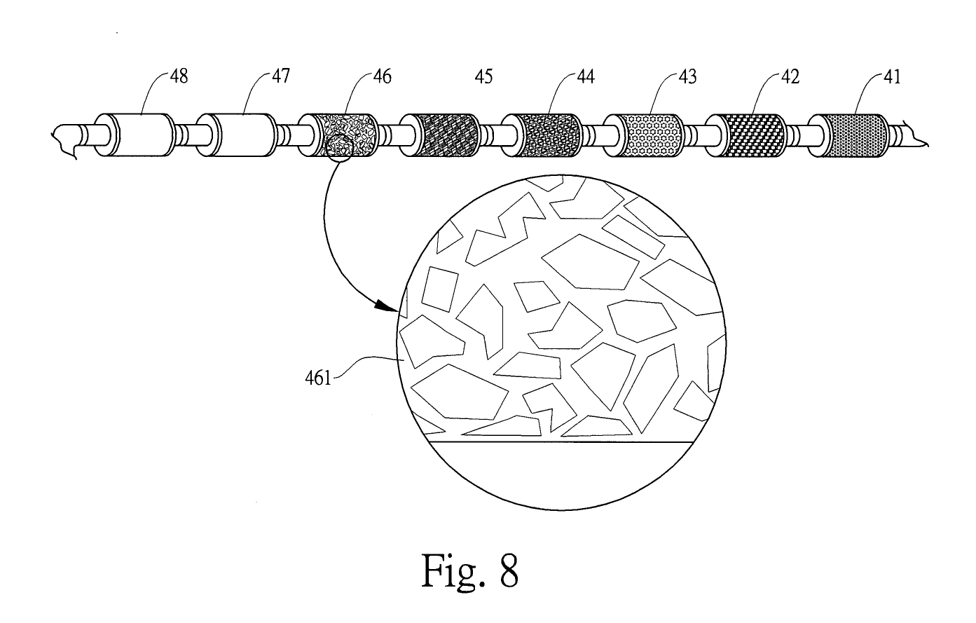

e) feeding the vapor into a plurality of first mineral stone collision devices 4 including a first body 41, a second body 42, a third body 43, a fourth body 44, a fifth body 45, a six body 46, a first anion processor 47, a second anion processor 48, etc. The first body 41 is placed with pellet shape mineral stones 411 (referring to FIG. 3); the second body is placed with tube shape stones 421 (referring to FIG. 4); the third body 43 is placed with star shape mineral stones 431 (referring to FIG. 5); the fourth body 44 is placed with triangular shape mineral stones 441 (referring to FIG. 6); the fifth body is placed with U shape mineral stones 451 (referring to FIG. 7); and the sixth body is placed with irregular shape mineral stones (referring to FIG. 8). The mineral stones of different shapes serve to decompose the molecules of the water into fine water molecules. The first anion processor 47 and second anion processor 48 serve to increase the anions in water so as to increase oxygen containing in the water;

f) cooling the fine water molecules in a condenser 5;

g) driving the cooling fine water molecules through a plurality of second mineral stone collision devices 6 which has the same structure as the first mineral stone collision device 4 so as to fix the shape of the fine water molecules by this collision process;

h) driving the shaped fine water molecules to flow through maifan stones 7 (i. e., Latite porphyry)which is formed by silicic acid; aluminum oxide; iron, calcium; manganese; magnesium; potassium; phosphorous; etc. These minerals have the properties of easily dissolving in water. Aluminum, iron, calcium, manganese, magnesium, potassium, and phosphorous are necessary to human body. Thus the processed water is called as active water.

i) forming fine water molecules as the water passing through the maifan stones, wherein the water molecules have long time period effect and have finer sizes;

j) feeding the fine water molecules into a supersonic oscillating device 8 for oscillating the water molecules by supersonic so as to stabilize the water molecules;

k) sterilizing germs in the water molecules by for example ultraviolet rays;

l) storing the water molecules into storage tanks 9.

Above mentioned mineral stones include minerals, which may be Leolithe stones, Latite porphyry stones, Actinolite stones, bubble generating stones, other mineral stones processed through high temperature.

In the present invention, the water is collided by filtering, heating, mineral stone collision, anion processing, condensing, shaping, flowing through Latite porphyry stones or other mineral stones processed through high temperature, supersonic oscillation, and sterilization so as to have fine water molecules which are retained through long time periods and fine sizes which can be retained through one or two years without composing into water molecules of larger sizes.

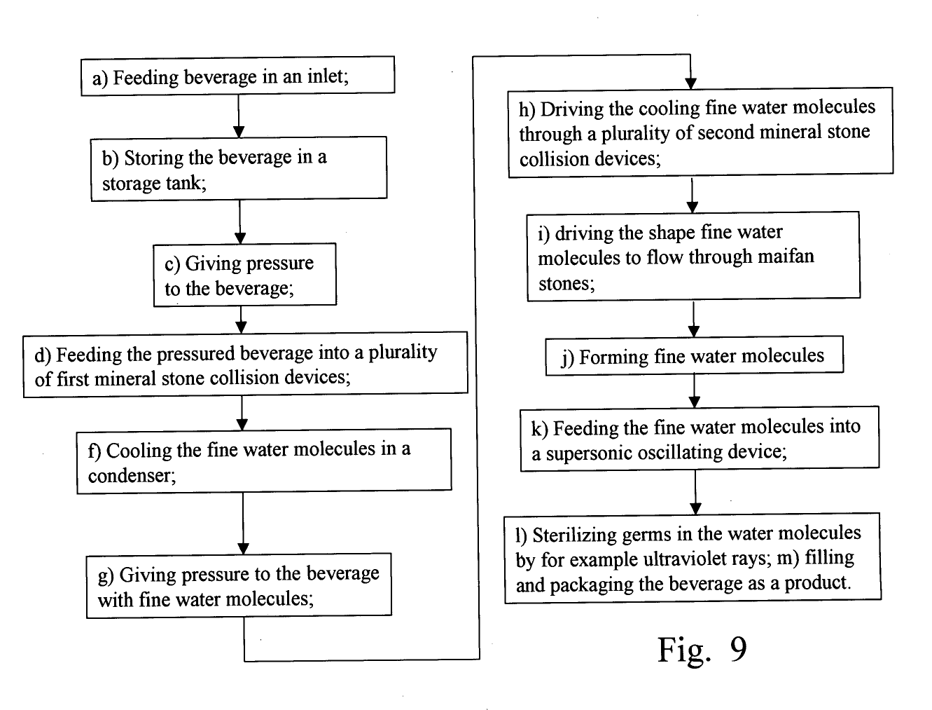

Referring to FIG. 9, an application of the present invention is illustrated. In the process, the water can be replaced by beverage (such as juicy, but not confined to this). The processing containing the steps of: a) feeding beverage in an inlet; b) storing the beverage in a storage tank; c) giving pressure to the beverage; d) feeding the pressured beverage into a plurality of first mineral stone collision devices to form beverage with fine water molecules; f) cooling the fine water molecules in a condenser; g) giving pressure to the beverage with fine water molecules; h) driving the cooling fine water molecules through a plurality of second mineral stone collision devices so as to fix the shape of the fine water molecules by this collision process; i) driving the shape fine water molecules to flow through maifan stones (i. e., Latite porphyry); j) forming fine water molecules as the water passing through the maifan stones, wherein the water molecules have long time period effect and have fine sizes; k) feeding the fine water molecules into a supersonic oscillating device for oscillating the water molecules by supersonic so as to stabilize the water molecules; l) sterilizing germs in the water molecules by for example ultraviolet rays; m) filling and packaging the beverage as a product.

The process of the present invention is performed in a sealing germless chamber. All the pipes used are not exposed out.

The water processed through the present invention has oxygen containing ratio of 8 ppm (in general water, the data is 1 ppm). Thereby the present invention has the effect of increasing oxygen containing.

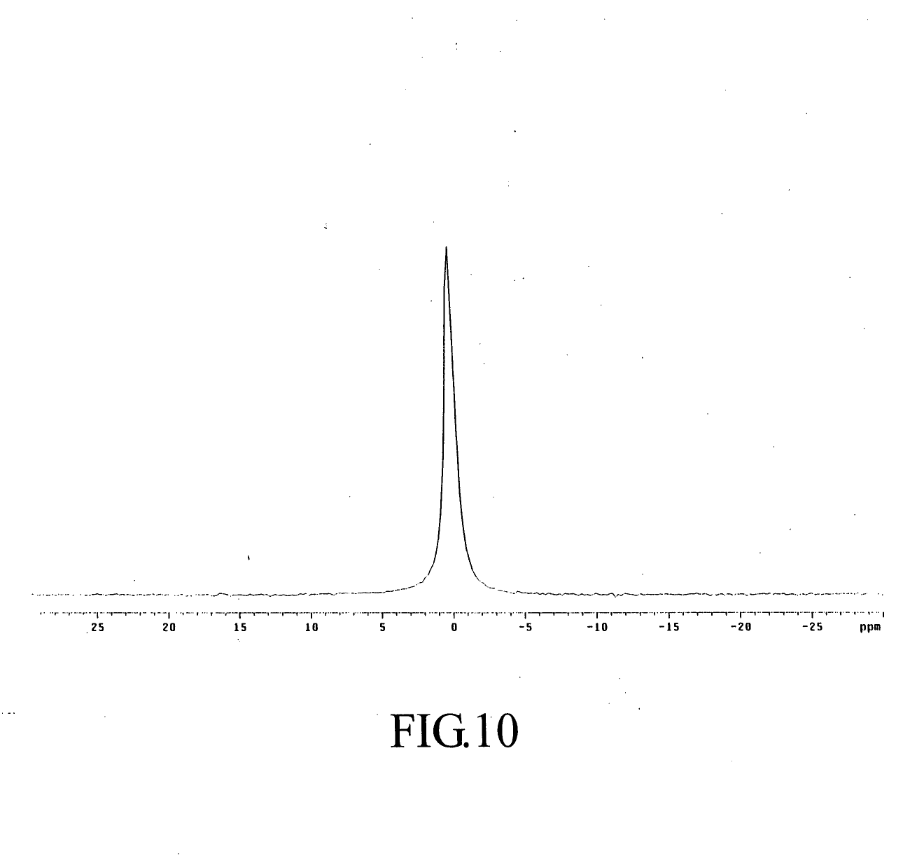

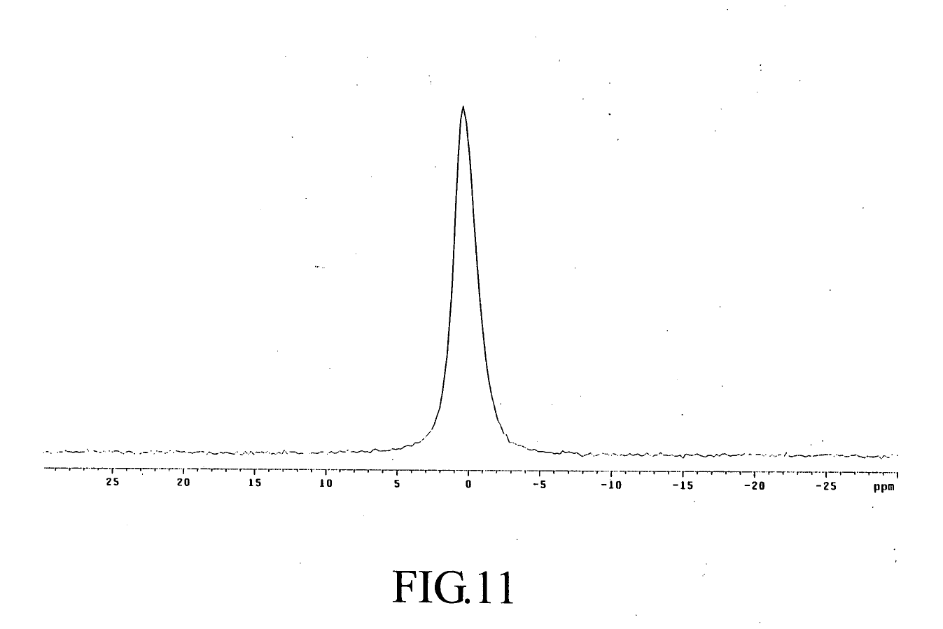

Referring to FIG. 10, it is illustrated that the water processed by the method of the present invention is tested in a high magnetic field nuclear magnetic resonance device under a condition of 500 MHz, 17-O-NMR. A reference data is illustrated in FIG. 10 with a nuclear magnetic resonance value of 56.786 Hz. The same test is applied to water, while a 125.375 Hz nuclear magnetic resonance value is acquired. Thereby the effect of the present invention is better than the general used water.

The present invention comprises an apparatus for forming fine water molecules. The apparatus comprises an reverse osmosis device having a water inlet; a storage tank for storing water processed by the RO reverse osmosis device; a heating device for boiling water in the storage tank into vapor; a plurality of mineral collision devices for colliding the water molecules into fine water molecules; a plurality of maifan stones for releasing minerals into waters; a supersonic oscillating device for stabilizing water molecules; and a storage tank for storing the fine water molecules.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for fining water molecules comprising the steps of:
a) feeding water in an inlet;
b) driving the water to flow through a reverse osmosis device for filtering impurities;
c) storing the water in a storage tank;
d) feeding the water to a heating device for boiling the water into vapor;
e) feeding the vapor into a plurality of first mineral stone collision devices so as to form fine water molecules;
f) cooling the fine water molecules in a condenser;
g) driving the cooling fine water molecules through a plurality of second mineral stone collision devices to fix the shape of the fine water molecules by this collision process;
h) driving the shape fine water molecules to flow through maifan stones;
i) forming fine water molecules as the water passing through the maifan stones, wherein the water molecules have long time period effect and have fine sizes;
j) feeding the fine water molecules into a supersonic oscillating device for oscillating the water molecules by supersonic so as to stabilize the water molecules; and
k) sterilizing germs in the water molecules by ultraviolet rays.

2. The method of claim 1, wherein the heat device is a boiler for boiling water into vapor.

3. The method of claim 1, wherein each of the first and second mineral stone collision device including a first body, a second body, a third body, a fourth body, a fifth body, and a six body; pellet shape mineral stones; tube shape stones; star shape mineral stones; triangular shape mineral stones; U shape mineral stones; irregular shape mineral stones are placed into the first to sixth bodies.

4. The method of claim 1, wherein each of the first and second mineral stone collision device further comprises at least one anion processor.

5. The method of claim 1, wherein the maifan stones is Latite porphyry which is formed by silicic acid; aluminum oxide; iron, calcium; manganese; magnesium; potassium; and phosphorous.

6. An apparatus for forming fine water molecules comprising:
an reverse osmosis device having a water inlet;
a storage tank for storing water processed by the RO reverse osmosis device;
a heating device for boiling water in the storage tank into vapor;
a plurality of mineral collision devices for colliding the water molecules into fine water molecules;
a plurality of maifan stones for releasing minerals into waters;
a supersonic oscillating device for stabilizing water molecules; and
a storage tank for storing the fine water molecules.

7. The apparatus of claim 6, wherein each of the first and second mineral stone collision device includes a first body, a second body, a third body, a fourth body, a fifth body, and a six body; pellet shape mineral stones; tube shape stones; star shape mineral stones, triangular shape mineral stones; U shape mineral stones; irregular shape mineral stones are placed into the first to sixth bodies.

8. The apparatus of claim 6, wherein each of the first and second mineral stone collision device further comprises at least one anion processor.

9. The method of claim 6, wherein the maifan stones is Latite porphyry which is formed by silicic acid; aluminum oxide; iron, calcium; manganese; magnesium; potassium; and phosphorous.

10. A method for fining water molecules in beverage comprising the steps of:
a) feeding beverage in an inlet;
b) storing the beverage in a storage tank;
c) giving pressure to the beverage;
d) feeding the pressured beverage into a plurality of first mineral stone collision devices to form beverage with fine water molecules;
f) cooling the fine water molecules in a condenser;
g) giving pressure to the beverage with fine water molecules;
h) driving the cooling fine water molecules through a plurality of second mineral stone collision devices so as to fix the shape of the fine water molecules by this collision process;
i) driving the shape fine water molecules to flow through maifan stones;
j) forming fine water molecules as the water passing through the maifan stones, wherein the water molecules have long time period effect and have fine sizes;
k) feeding the fine water molecules into a supersonic oscillating device for oscillating the water molecules by supersonic so as to stabilize the water molecules;
l) sterilizing germs in the water molecules by for example ultraviolet rays;
m) filling and packaging the beverage as a product.

11. The method of claim 10, wherein the maifan stones is Latite porphyry which is formed by silicic acid; aluminum oxide; iron, calcium; manganese; magnesium; potassium; and phosphorous.
